(19) United States
(12) Patent Application Publication
(10) Pub. No.: US 2003/0136875 A1
(43) Pub. Date: Jul. 24, 2003

(54) Aircraft with rotary wings

(76) Inventor: Daniel Pauchard, Pirotte (FR)

Correspondence Address: YOUNG & THOMPSON, 745 SOUTH 23RD STREET 2ND FLOOR, ARLINGTON, VA, 22202

(21) Appl. No.: 10/181,691

(22) PCT Filed: Jan. 18, 2001
(86) PCT No.: PCT/FR01/00149

(30) Foreign Application Priority Data
Jan. 20, 2000 (FR) 00/00731

(51) Int. Cl. B64C 27/00

(52) U.S. Cl. 244/17.11

(57) ABSTRACT

This aircraft contains a central cabin around which are two coaxial compensating rotary rotors synchronized presenting each a crown (2, 3) and at least two wings. The cabin contains two structural rings (10, 11) connected to each other and guiding the rotors.

Some means allowing to modify the pitch of wings are made of two oscillating rings (31, 32). Every oscillating ring is associated to a crown (2, 3), in concentric to it, is made rotating by the crown, and is linked to the wings of the corresponding crown by rods or cables.

Every oscillating ring (31, 32) is linked to vertical means of transport and movement around a transversal axis to present a chosen distance regarding to the corresponding crowns (2, 3) along a circumference.

The guidance of crowns on the structural rings (10, 11) is realized by means of pebbles (30) of perpendicular axis to the plan containing a structural ring and the corresponding crown, pebbles and the wings being equally displayed between the structural ring and the corresponding crown.

This invention belongs to the field of aircrafts with rotary wings, which includes helicopters and gyro airships in particular. It particularly concerns a gyropter with two coaxial rotary opposite rotors.

We generally know this kind of devices as described in the French patent no 2 584 044(“Aircraft with rotary wings of simplified and light structure”) deposited on Sep. 27, 1985 by the inventor of the present demand, and in the demand PCT/FR86/00330 (“Aircraft with rotary wings ”), deposited on Sep. 26, 1986 under priority of the previous demand. These two documents describe the general structure of a gyropter in details. They are the technological background of the present demand.

Let us remind that it is about a flying machine with coaxial rotary opposite rotors gone up on two crowns around a cabin acting as cockpit. Such flying machine is a generic conception which can have several sizes and several uses.

This very invention offers a gyropter allowing a better understanding of a secure way of flying. This best mastery will be rather followed by a decrease of the vibrations of the device.

The invention then offers an aircraft made of rotary wings of the gyropter type with a central cabin in the midst around are mobile in rotation two synchronized rotary coaxial rotors, each one presenting one crown and at least two wings, the cabin containing two structural rings connected by crossbars and serving of guides for rotors, means being foreseen to modify the pitch of every wing.

According to the invention, this aircraft is characterized in what means allowing to modify the pitch of wing contain two oscillating rings, every ring being associated to a crown in being concentric in the aforementioned crown, pulled in rotation by the crown, sticking together in the wing of the corresponding crown by means of transmission of movement of type rods or the cables adapted to modify the pitch the aforementioned wing, so that every oscillating ring is shown solidarity in means of vertical transport and movement around a transverse axis therefore allowing to present a chosen distance facing the corresponding crown along a circumference, and it what the guide of crowns on the structural rings is realized by means of pebbles of perpendicular axis in the plan containing a structural ring and the corresponding crown, Pebbles and the being at equal distance of the wings between the structural ring and the corresponding crown to which one or two pebbles is corresponding.

In this way, thanks to the combination of the good running of crowns on the structural rings and the gearing thanks to oscillating rings, the flight of the aircraft is safer.

For their training, for example each crowns presents a tilted track of training, both tracks in front of each other, and the running of crowns is assured by an unclogged tangential conical wheel. This means of training with a tangential conical wheel, contributes with the gearing of the crown to a better stability of the device thanks to the decrease of vibrations.

Advantageously, a free of brake wheel is on the opposite side of the tangential wheel.

In one of the map of the aircraft, the oscillating rings are led by action on quite horizontal articulated arm to which are connected two kneepads, each carrying a ball and thanks to them two vertical stirrups each carrying a system of allowing the movement of the corresponding oscillating ring.

In this type of setting, every articulated arm is for example geared by a mobile handlebars between to two axes and by a pedaled rudder, and the movement of the handlebars and the rudder is passed on to the oscillating rings by a curtain-rod which may use cables to allow to vary their transverse angular position and their vertical position with regard to crowns as well as their vertical spacing.

A variant of realization foresees for example that the means of vertical transport (Z) oscillating rings include, on each side of the cabin, an arm of control of the oscillating rings arranged according to an appreciably longitudinal direction (X), united of a means of vertical training (centre Z) in its center placed appreciably according to the transverse axis of the aircraft, every arm of control bearing in each of its two opposites a set of control of pitch including a means to modify vertical spacing between two oscillating rings and to allow their free movement during their rotation, that means of transport around the transverse axis (Y) oscillating rings include in this variant advantageously means of training in rotation of every arm of control around a transverse axis (Y), that the means of training in rotation of every arm of control includes an united pedal of a rod linked to a commanded arm, that the aircraft contains a mobile handlebars according to two axes, every handle of which is connected with a bar pulling an arm of control in vertical movement (Z), both bars being able to be moved into simultaneous vertical movement (pushed or pulled handlebars) or horizontal (handlebars set on one side or on the other one), that every set of control of pitch contains a slightly horizontal commanded arm to which are connected two kneepads each carrying a ball and by their intermediary two appreciably vertical stirrups each carrying a device allowing the movement of an oscillating ring, and a wheel is set every end of every arm of control, in is changed into rotation by a cable modifying the center distance of two oscillating rings.

When the oscillating rings are controlled each by an arm of joint, every arm of joint itself is for example controlled from a set two sleeves and a rudder, the movement of sleeves and rudder is as for him for example passed on in the oscillating rings of sliding cables in one girdle connected with the structure of the aircraft by means of a detail in cross to allow to vary the transverse angular position of the oscillating rings and their vertical position with regard to crowns as well as their vertical spacing.

In another shape of realization, the oscillating rings can also be controlled by cables which are in direct connection with remote-controlled servomotors (drone or automatic piloting).

In order to increase the safety but also the stability of the aircraft, it also contains for example at least a circular ring of gear the whirlpools, acting as an wind flow vibration absorbent, safety landing and of protection whose diameter is bigger than that of the wing, and the circular ring of protection is rather a supple ribbon, interlocked to a couple of wing, and moved in rotation with wings.

The description and drawing which follow will help you to better understand aims and advantages of the invention. It is clear that this description is given as example, and has no restrictive character. In the drawing:

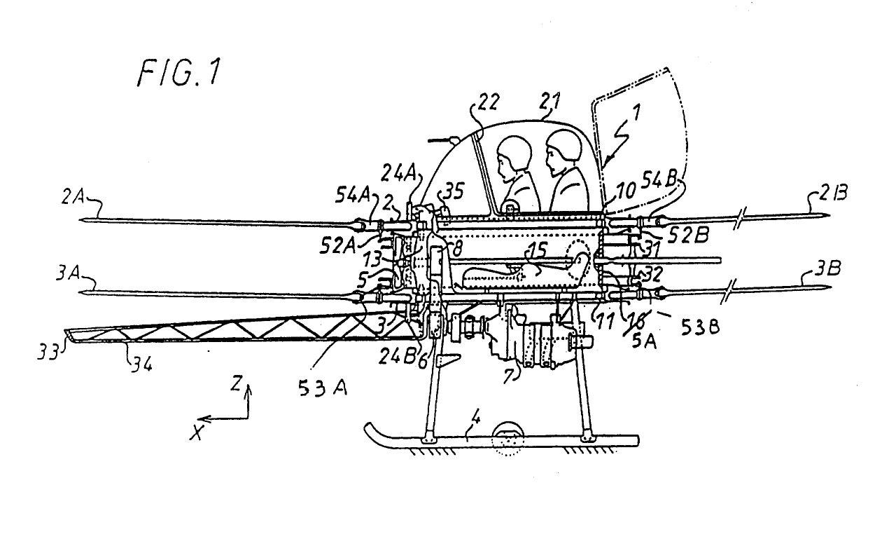

FIG. 1 shows an aircraft according to the invention (sideways),

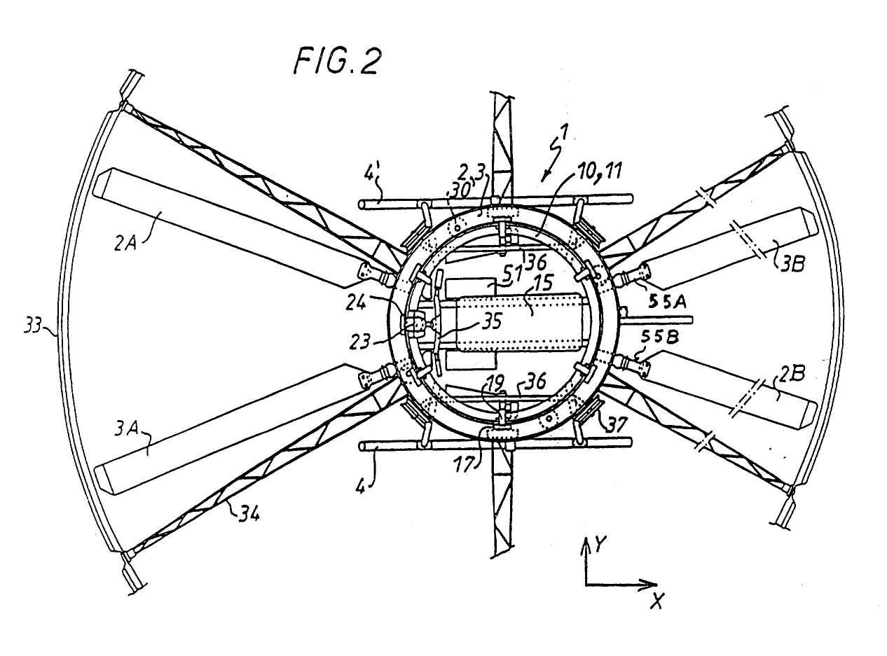

FIG. 2 illustrates the same device (from above),

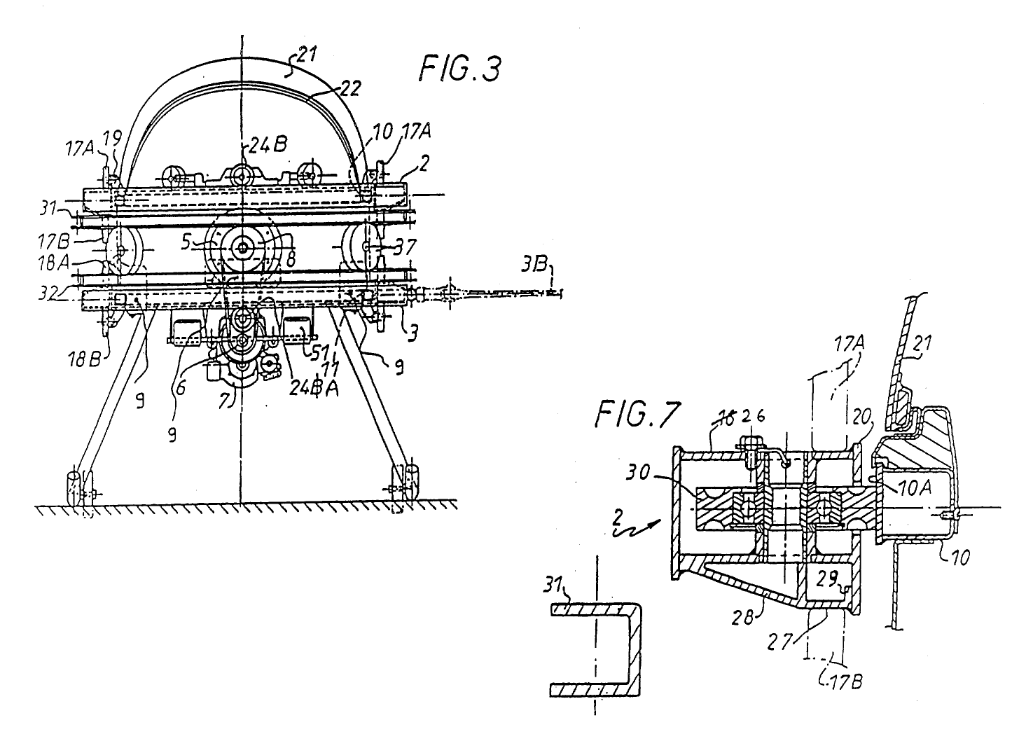

FIG. 3 illustrates the same device with a front view, without the two groups of compensating rotating wings,

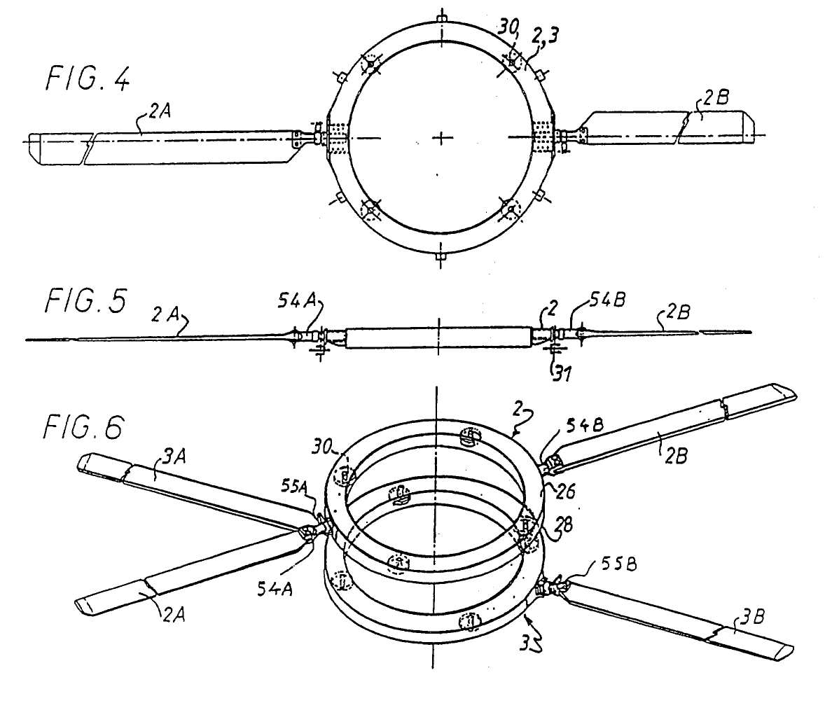

FIG. 4 shows a top sight of a crown,

FIG. 5 shows a crown (sideways),

FIG. 6 shows in perspective two crowns carrying compensating rotary wings,

FIG. 7 shows a section view, a pebble of radial guidance of a crown on the corresponding ring,

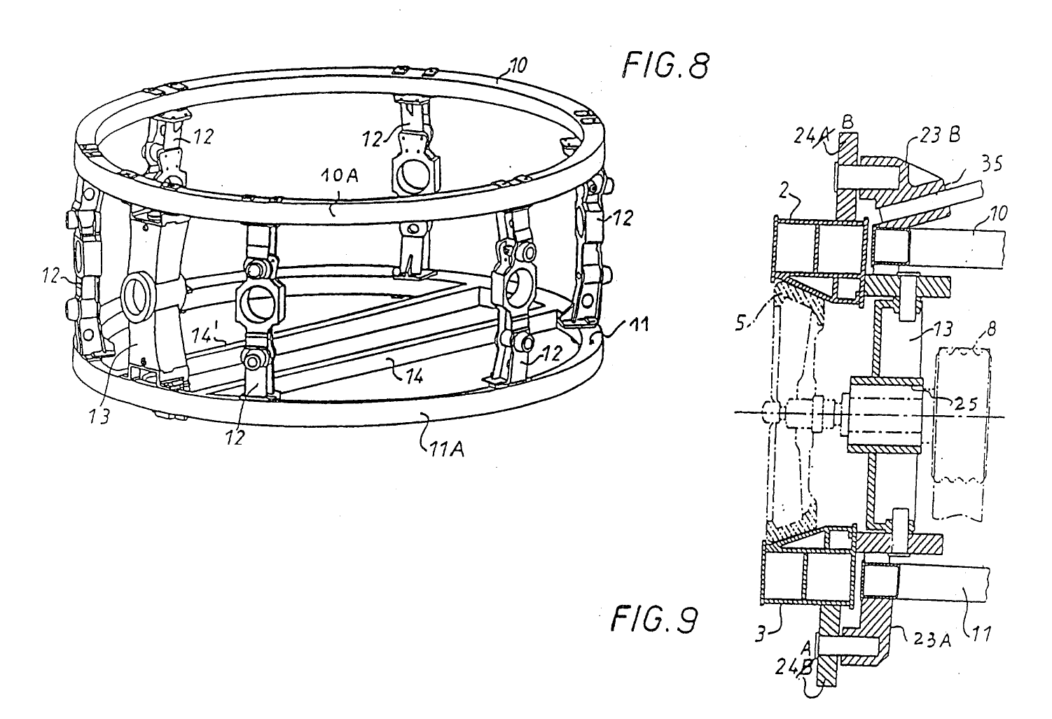

FIG. 8 shows in perspective the structure of the cabin and bars of support for the passengers' seats,

FIG. 9 is a section view of the device making the crowns start at the level of the crossbar,

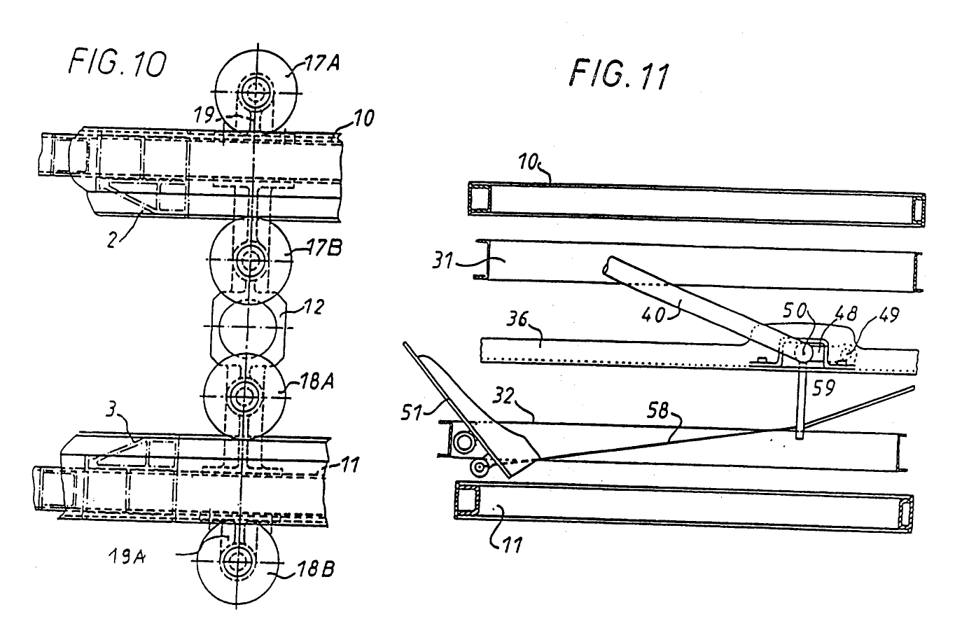

FIG. 10 illustrates with a front view a cabin crossbar as well as the rolling pebbles of crowns and the mooring of an arm of control of the oscillating rings,

FIG. 11 illustrates (sideways view) the rods of controls of position of an arm of control and the mooring of an arm of control of the oscillating rings (in details),

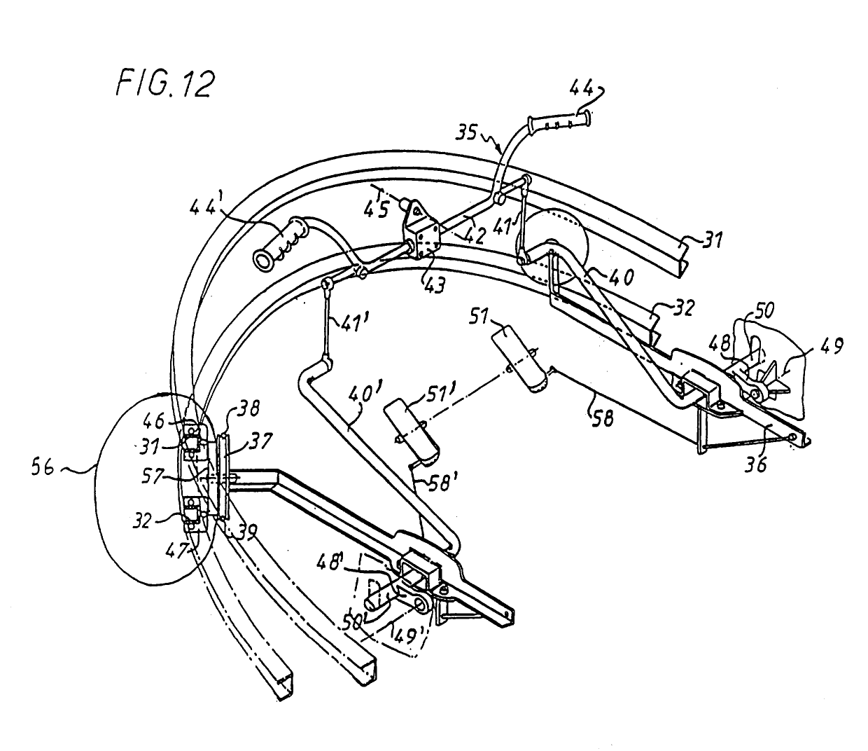

FIG. 12 illustrates in perspective the mechanics of control of the arms of controls by the handlebars and the pedals, as well as the detail of the wheels of control of the oscillating rings,

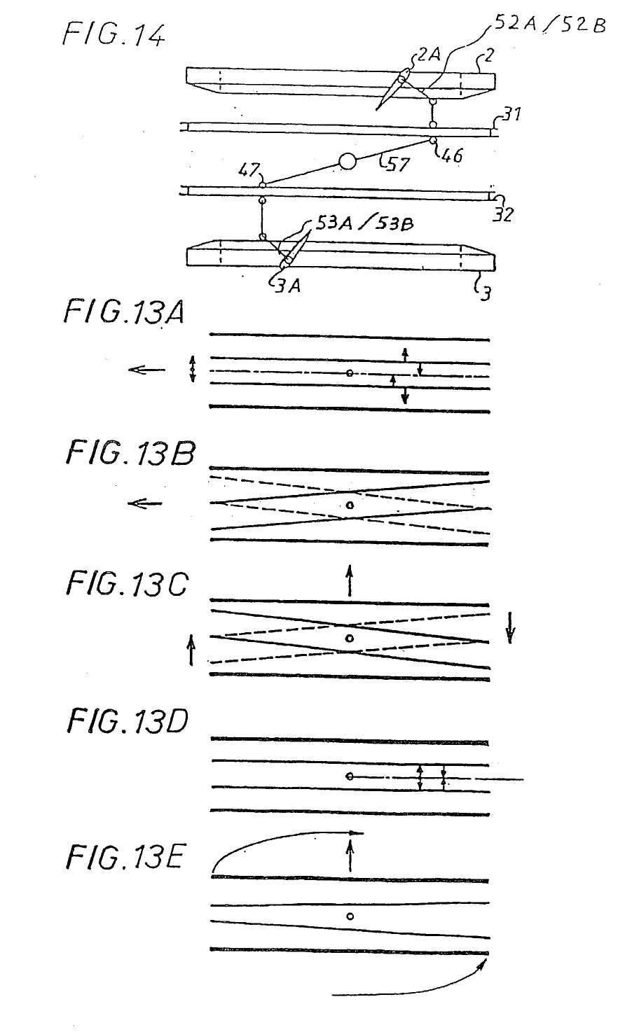

FIG. 13A in 13 show the disposal of the oscillating rings with regard to crowns according to the various controls of flight,

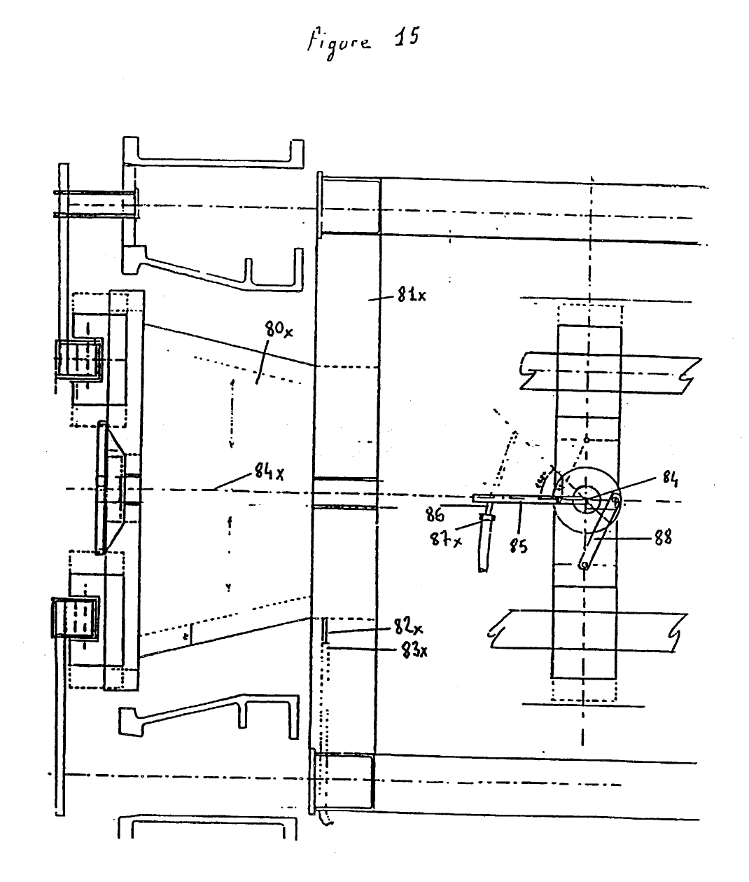

FIG. 14 illustrates in a simplistic way the principle of control of pitch of wings by the oscillating rings,

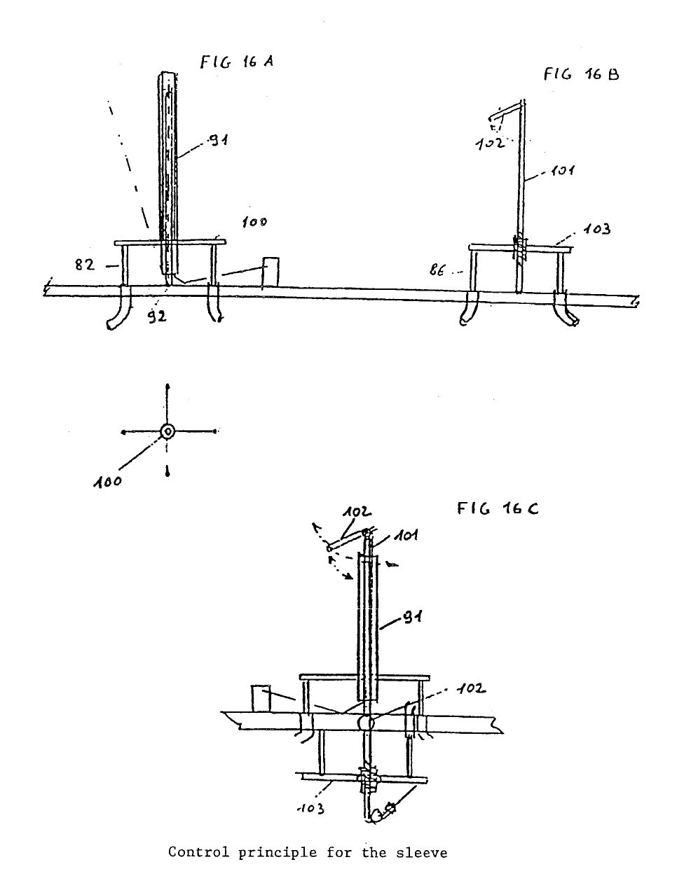

FIG. 15 represents a choice of stirrups guidance in their vertical movement, and therefore that of the rings, with for instance that of a control by means of cables, and

FIGS. 16A and 16B present an example of the cables piloting and FIG. 16C an example of controls regrouped and synchronized of these same cables.

The invention takes place in the general frame of gyropters such as described in documents first quoted, to which it is made reference for the details of realization not described here.

Directions for the pilots are defined in the following description, that it is to say a main plan of the aircraft defined by the rotation plan of each wing, a front direction being the one that the pilots consider (longitudinal axis X in the main plan) and which is the direction of the aircraft, a lateral direction (centre Y) perpendicular to the axis X in the main plan and a vertical direction (centre Z) perpendicular to the main plan of the aircraft.

The device is an aircraft with rotary wings of light structure containing a cabin defining the position of or users partially power plant.

Around this cabin 1 (the mode of fixing will be described later on), the aircraft contains two identical compensating rotating crowns, bearing each at least two wings 2A, 2B, 3A, 3B positioned at the opposite (forming compensating rotating rotors of the device) with a control system of the variation of the cyclic of pitch (described farther down), compensating rotary crowns respectively superior 2 and subordinate 3 assure training in rotation and maintain the wedging of wings 2A, 2B, 3A, 3B of the rotor wings 2A, 2B, 3A, 3B of every rotor is fixed to hubs in the suburb of each crown 2, 3. Two compensating rotary crowns 2, 3 are naturally mobile in rotation around the same vertical axis Z forming the vertical axis of the aircraft.

In the indicative application of two-seater type illustrated on pictures and described here, rotors have a diameter of 5,55 m, the length of wing is 1,805 m, for an average width of wing of 20 cm. In this none restrictive example, the vertical space between two compensating rotary rotors is near of 45 cm.

This cabin 1 contains among others means of ground support, under shape for example of a two skates landing gear for 4, 4′ classic type.

The landing gear 4, 4′ is for classical structure and can be provided with two ball cocks (which can be taken away), in supple material, folded, being able to be operated in flight by inflating with the aim of a sea-landing.

One understands that by construction the centre of gravity of the device is placed between two compensating rotary crowns 2, 3. The device being for the rest on the ground, the lower crown 3 is in a height of 90 cm above the ground (defined by the size of skates) as a rough guide.

The training of two compensating rotary crowns 2, 3 is ensured by a wheel tangential 5 in the plan intrados for the upper crown 2 and extrados for the lower crown 3. The tangential wheel 5 presents a conical rim and elastomer tread. It pulls in upper and lower opposition on treated or grooved plans corresponding on two compensating rotating crowns 2, 3 and ensures the rotation of crowns so that they cannot slip.

The tangential wheel 5 of the training is placed for example partly in front of the device here (it should be said in front of the pilots). This training wheel 5 is pulled by a propeller shaft 6 connected with a fixed engine 7 under the cabin 1 according to the longitudinal axis of the aircraft. More exactly, the engine 7 triggers through a short tree, through a cog and through a notched belt, a toothed crown 8 united of the tangential driving wheel 5.

The engine 7, the propeller shaft 6 and the tangential wheel 5 are of the classic type. The engine 7 is for example, but in a none limitative way, a piston motor, of 100 CV of power, associated to a reducer of report ½, and pulling a centrifugal clutch. The regime of rotation of two opposite rotary rotors is in that case of the order of 450 tours per minute.

In the present example, three reservoirs 9 are displayed on the edges of the cabin 1 (to see FIG. 3) with for example respective volumes of 40 liters (axial reservoir) and 20 liters side reservoirs). They are arranged so as to maintain a side balancing of the aircraft.

Transmission is a kinematics with reducing, by notched belt or all other system to ensure the transportation of the engine's energy in the tangential engine wheel 5.

The tangential wheel 5 is fixed on a helical axis, which allows, by its longitudinal movement on this axis, the clutch when the rotating system of transmission is on and the declutching when it is of.

In a variant of realization, a free tangential wheel 5A (picture 1) fixed at the opposite and advantageously provided with a variable paced and careened helix, allows by the piloting of the incidence of these wings, some additive push. In that case, a brake fixed on the tangential free wheel allows the immobilization of wings in a few seconds if necessary. This wheel maintains synchronized crowns during the declutching of the tangential wheel 5.

In the type of realization described here as not restrictive example, the cabin 1 (appear 8) is made of two structural rings respectively superior 10 and subordinate 11, realized in no deformable material and of whose sides, outsides 10 In, 11 In, are directly placed in front of crowns 2, 3.

With the aim of guiding the crown 2, 3 correspondent of a free-rotating mobile way (around the vertical axis Z), every ring 10 (respectively 11) bears six pairs of pebbles 17A, 17B of radial guidance (respectively 18A, 18B) arranged in intervals of 60°, adapted to turn around convergent radial axes nerves on the vertical axis Z of the aircraft, and that come to run on the upper and lower faces of crowns 2, 3.

Every pebble of radial guidances nerve 17A, 17B, 18A, 18B is linked to a structural ring 10, 11 by a bended fixation 19, welded or screwed on the ring. The picture 7 shows the detail of the device of radial guidance nerve of the crown around the ring. Every crown is provided with a vertical stringer 20 on its upper face.

These structural rings 10, 11 are connected by a series of crossbars 12 regularly arranged with angles of 60° in the right of supports 19 of pebbles 17, 18, and by a support of transmission 13 of the tangential wheel 5.

The lower ring 11 is linked by weld to two parallel central girders 14, 14′ which are of use of structure of support notably to a seat 15, as well as to the driving group 7, to various transmission elements, to cabin equipments and to the landing gear 4, 4′ fixations.

The upper ring 10 bears a window “lounge” 21, removable (see picture 1) to allow the entrance and the exit of the pilots. The upper ring 10 also carries elements of fixation of an arch 22 of safety, the frame of the cockpit, and the different equipments which are not detailed here.

The bubble 21 of the completely transparent cockpit (high part) is in two parts closing on the safety 22 arch. The safety 22 arch, that has a permanent shape, which a pyrotechnic parachute in automatic release and a grip joking, are solidly fixed to the machine structure by means known and not detailed here.

The support of transmission 13 fixed to two structural rings 10, 11 in the axis of flight X of the device (in front of the pilots), carries to its bottom one built driving transmission support (appear 3), as well as a support 23A of pebbles 24A of constraint adapted to resume the deformation effort due to the push of the tangential wheel 5 on the lower crown 3 (appear 9).

The central part of this support of transmission 13 contains an boring 25 for the passage of the axis of the tangential wheel 5.

The upper part of this transmission support 13 contains a place for an handlebars 35 axis of driving, as well as a 23B support of 24B pebbles of constraint adapted to resume the effort of deformation due to the push of the tangential wheel 5 on the upper crown 2.

The two compensating rotary crowns 2, 3 are better realized for reasons of lightness and solidity in miscellany of aluminium or of titanium or in dissimilar building material. They are symmetrical and composed each of two flasks, first flask 26 plan, carrying the number 20 stringer of border, the second flask 27, containing a tilted track of training 28 and the second stringer of border 29. These two flasks 26, 27 spaced out compose a sort of box opened, in that one can accommodate different equipments.

Two flasks 26, 27 of the same crown (for example crown upper 2) are connected among them by:

Four straps of fixation (not shown on pictures), two on the right part of the aircraft and two on the left part in a symmetric way,

Stirrups (also not shown) forming support of wing 2A, 2B set carried by the crown 2,

Four pebbles 30 (picture 2) of axial guidance of the crown 2 on the corresponding ring 10,

Four vertical plates off outside mechanical connection and four plates of internal mechanical connection between the two flasks forming crowns,

Six training plates of two oscillating rings 31, 32 of control of pitch.

The cabin 1 can also contain a protection ring 33 in supple material arranged beneath and just beyond the limit of passage of the ends of wing 2A, 2B, 3A, 3B.

This protection ring 33 is linked to the cabin at the level of the ring 3 subordinate by six checkmates tryingly 34. A more sophisticated dock can be possible, according to demands. For example, a device called “hula hop”, fixed at the end of wing and moving in rotation with them, is possible. It is for example possible to use a supple ribbon, for example linked to the ends of the low wings, put in rotation collectively with wings, and that so takes a shape of ring protection.

So protected, wings 2A, 2B, 3A, 3B are no longer dangerous in rotation to the ground.

One notes that in that case the whirling streams of the wings' ends are better canalized, therefore decreasing noise as well as the trail and reduces the floating phenomenon when approaching.

The control system of flight (rolling, lace, reeling, cyclic) uses a variation of the pitch (that is to say the angle of attack of the wings in the air, determines its lift (holder)) of every wing either during every tour, or in a constant way during the tour.

This variation of pitch is realized by the use of the oscillating concentric rings 31, 32 with crowns 2, 3 that are connected by rods 52A, 52B, 53A, 53B in the hub 54A, 54B, 55A, 55B of every wing 2A, 2B, 3A, 3B (appear 6), and of that angular position with regard to the plan of crowns 2, 3 is determined by a game of curtain rod (whose detail is given further down) connected to the handlebars 35 and to reeling pedals 51 (rudder). Other devices are possible, for example with controls by cables of type CBA or other types.

Every oscillating ring 31, 32 is pulled in rotation by the crown 2, 3 corresponding thanks six sliding stalks (appear 4) connecting crowns with their respective ring. More precisely, the six training patches of every ring on the corresponding crown carry each a boring for the passage of a guidance and training stalk of the oscillating ring. On the axis realized by this boring comes to slide a stalk connected to the oscillating ring.

Every oscillating ring 31, 32 modifies by means of rod 52A, 52B, 53A, 53B (one for every wing 2A, 2B, 3A, 3B respectively) the incidence of the wing of the crown 2, 3 that corresponds to it. The principle of this movement is illustrated by the picture 14.

One understands on that principle, that the increase of the pitch (pace) of a wing 2A, 2B, 3A, 3B trigger an increase of local lift, while the decrease of this pitch triggers a decrease of lift.

For example, the general increase of the pitch during all the rotation of wing 2A, 2B, 3A, 3B will increase the total lift, with a resultant strength upward, provoking an acceleration of the aircraft upward, and if it is initially put on the ground, the takeoff.

More generally, by the relative move of the lifts of wing 2A, 2B, 3A, 3B of every crown 2, 3 one can so control movements of the aircraft in translation according to all the directions X, There, Z and in rotation around all the axes of flight.

It is so the position of the oscillating rings 31, 32 with regard to crowns 2, 3 that determine all the controls of pitch (incidence) of wings 2A, 2B, 3A, 3B.

These oscillating rings 31, 32 remain parallel among them for the controls of general pitch (ascent and descent) and for the controls of reeling, of rolling, and of lace.

For the cyclic of pace, it is the angular variation of the oscillating rings 31, 32 among them that ensures this function (the oscillating rings 31, 32 are not then more parallel in the axis X of flight, and there is a variation of the pitch (incidences) of wing in rotation to compensate for the differential effects of the relative wind enters the advanced wing the wind which closes and decreases its pitch (incidence) and the remote wing which opens and increases its incidence.

Different control systems of these oscillating rings 31, 32 are then possible. A control by control joystick of classic type and rudder is possible.

In that very example described in non-limitative way, a control system of the oscillating rings 31, 32 by handlebars on the one hand, and rudder on the other hand is foreseen. An adapted rod passes on the controls of the pilot to the oscillating rings 31, 32.

More precisely, in this operation, the controls the pilot has in charge, on the one hand, a handlebars 35 moving according to two axes (rolling, lace, and collective controls), and, on the other hand, a rudder 51 (reeling control) containing two pedals of the classical type.

Now making reference to the picture 12, one sees that the handlebars 35 includes two handles 44, 44 connected by bended tubes (not referenced) with a straight tube 42. The handle 44 placed to the right is mobile in rotation of a way similar to the handles of motorcycle, and serves of control of regime of the engine, and so of speed of rotation of compensating rotary rotors 2, 3.

The straight tube 42 is linked to a case 43 in which it is freely mobile in rotation according to a transverse axis (appreciably parallel to the side axis Y of the aircraft) to get for the pilot a control of collective (up and down).

This case 43 is fixed to the main structure of the cabin 1 (two structural rings 10, 11 connected by crossbars 12, 13) and at the level of the front crossbar 13. It is mobile in rotation on an axis 45, roughly parallel to the longitudinal axis X of the aircraft, in order to give the pilot a rolling control (lace to the right or to the left).

The straight tube 42, generally parallel to the side axis Y, is articulated in rotation in its extremities in two vertical bars of transmission 41, 41′ the later being each articulated at the end of the cockpit 1 thought a spur 48, 48′ Fixed Motive in rotation around the side axis Y in said cabin (at the level of the centre of the lateral crossbar 12 or on a dock fixed to the structural rings 10, 11).

One understands that in this way (see FIG. 12), the low transverse segment 50, 50′ of every bar in 40, 40′ is adapted to realize a movement of rotation (merged with a translatory movement for small angles of rotation) around said side axis Y according to the movements that the pilot communicates to the handlebars 35. It is clear that two bars 40, 41′ can be changed into simultaneous vertical movement (moved or fired handlebars) or set (sour handlebars on one side or of the other side).

On each side of the cabin 1, an arm of control 36 of the oscillating rings 31, 32 is arranged according to an appreciably longitudinal direction X (to see pictures 2 and 12), and pulled in vertical movement (centre Z) by the low segment 50 of a bar in “S” 40, in that it is linked to one obviously long one.

As regards the reeling control which determines the going to and fro of the aircraft, it is realized by support on pedals 51, 51′ (pictures 11 and 12). The support on these pedals 51, 51′ is transformed by a simple rod 58, 58′ in movement of turnly arms of control 36 (movement around the transversal axis Y).

A device allowing to transform controls on the handlebars 35 was so created and the pedals 51, 51′ in turn transverse (centre X) or vertical (centre Z) arms of control 36. These movements can be identical or opposed for the two arms of control 36.

Always in this operated of control, described in not restrictive title, four sets 56 of control of pitch, arranged in the ends of the arms of control 36, determine transverse angular position and the vertical position of the oscillating rings 31, 32 with regard to crowns 2, 3 according to controls received from the pilot, as well by the handlebars 35 as by the pedals 51, 51′. These sets 56 also serve for determining vertical spacing between two oscillating rings 31, 32 in the case of the control of late (rotation of the aircraft around the vertical axis Z).

Every set 56 of control of pitch (appear 12) contains an arm of joint 57 appreciably horizontal with which are connected two kneepads carrying each a ball and by their intermediary two slightly vertical stirrups 46, 47 each carrying two balls or other system of movement (allowing the movement of an oscillating ring 31, 32).

A wheel 37, taken up at the end of the arm of control 36, united of the arm of joint 57 piloted by a cable 38, 39 modifies the center distance of two oscillating rings 31, 32 for the control of lace and the control of cyclic pitch (corresponding to a control of compensation in translation). Every said cable cables in buckle 38, 39 crosses on horizontal roulettes of marketing research (not imagined) and is pulled by the low extremity 50 of a bar in “S” 40 (connected with the handlebars and with pedals). In particular, the slope of the handlebars allows the control of lace.

In functioning, the actions of piloting the aircraft are realized in the following way for five major controls.

Collective: This control, which corresponds or the going up and down of the device on whether in a static way or in movement, is realized by increase or decrease of lift equal for the two rotors (for symmetry reason).

A simultaneous vertical movement of the two arms of controls 36 is triggered by action on the handlebars 35, and provokes a vertical movement (centre Z) parallel of two oscillating rings 31, 32 at the same time as crowns 2, 3 (appear 13A).

Reeling: This control, which corresponds to the promotion or to the recession of the device by slope forwards or the back (rotation around the side axis Y), is realized by variation of lift between the front and the back of the device. A more important lift is provoked on the blade behind than on the one in front, for example, by increasing the pitch of the blade behind, and by reducing the pitch of the one at the front.

A simultaneous wind of the two arms of controls 36 is stated by action on pedals 51, 51′ and provokes an identical wind around the transverse axis (centre Y) two oscillating rings 31, 32 (picture13B).

Rolling: This control corresponds to a movement on one side or of another one of the device with regard to its axis of promotion. It is realized in the same way as the reeling order, but by increasing or decreasing the lift of wings on one side with regard to the other one.

A vertical movement upward is provoked for one of two arms of control 36 (of the side for which the lift is going to increase), whereas a vertical simultaneous movement downward the other arm of control 36 (of the side or the lift decreases, and to that the device is going to turn) is controlled, by action of rotation of the handlebars 35 around the longitudinal axis X, and provoke an identical wind around the longitudinal axis (centre X) two oscillating rings 31, 32 (appear 13C).

Lace: This control allows a rotation of the device around its vertical axis. It is obtained by making asymmetric lifts and the trails of two rotors, one of the rotors having then a trail lower than the other rotor, the two moments of rotation around the vertical axis do not cancel any more in that case.

A vertical movement of the two arms of controls 36 is controlled, by action on the cable 38, 39 and provokes a vertical set movement (centre Z) two oscillating rings 31, 32 (appear 13D).

Compensation (cyclic of pitch): compensation is a control allowing flight to be stabilized in translation of the aircraft. It is obtained by space of the oscillating rings 31, 32 on one side from the device (by action on the cable 38, 39) and approach of the oscillating rings 31, 32 on the other side of the device (by action on the other cable 38, 39), that results in a loss of parallelism of these (13 th picture). In stabilized flight in translation “oblique aircraft”, the lift is compensated with the both opposed crowns. The out of lift of a wing on a crown is compensated with the increase of lift on the other wing (on the opposite page in 90′ of the axis X) of the other crown.

It is clear that these various attitudes can be combined, for a natural piloting of the aircraft. The transmission of all the controls by the oscillating rings 31, 32 ensures a very great progression of controls, and avoids any kinds of bumps.

As a variation, the control of the pitch of wing is realized by an electronic system directly controlling electric engines integrated into crowns 2, 3.

The setting of the cabin and mechanical elements is known to professionals, and can for example but in a non restrictive way include tubular structures, tools, welded etc., in materials such as titanium, aluminium. Dissimilar structures can also be made possible with variations operated by professionals one understands besides that controls can be is realized by a pilot, is by all other system such as radio controls, remote control by use of GPS system and video etc.

For another improvement of gyropter's safety and the concept of the rings position for the control of the wing angle, here is a series of variants for the controls of flight.

More precisely in this operation (picture 15), control by cable uses sliding 80x not presented first and useful in maintaining hands with guidance balls of the oscillating rings, placed slightly diagonal, and in a symmetrical way the sliding are guided by their respective crossbars 81x.

Vertical movement is assured by cables 82x whose extremity girdle 83x is fixed to the structure with a system of control lever not presented for a more precise control.

The sliding carry axes 84x connected to every group of hands with balls, movement according to the axis (z) of these sliding ensure the controls of general pitch, reeling and rolling.

Axes 84x each carry an arm of control lever 85 to which two rods 88 are fixed in a symmetric way with regard to this axis, these rods ensures the symmetrical vertical movement of hands with balls, by the rotation of the control lever arm by means of a cable 86 whose extremity 87x is fixed to its sliding sound.

The other extremities of the four girdles cables 82x are fixed (picture 16A) to the structure in diagonal and below a cross 100 motive vertically for the control of general pitch and in all the directions in synchronization for the controls of reeling, of rolling or mixed (both), thanks to one sleeve 91 basic extremity 92 of which is positioned on the structure and of which the other extremity is the handle of control.

The other extremities of the girdles of four cables 86 are fixed (picture 16B) to the structure in diagonal and compared to a detail in cross 103 motive vertically for the control of lace and in all the directions in synchronization for the control of the cyclic of compensation of the relative wind.

Sleeve 101 of this control is made of a handle 102 allowing the pilot to decide on a new direction to set, this handle 102 allows the rotation of sleeve which has in its bottom a gearing in saw, allowing to pull or to push the four cables of the same movement pinching out and homogeneous space of rings for the lace control).

The slope of sleeve 101 whose end is fixed to the structure ensures the pinching out of rings for the control of cyclic function of the direction of the relative wind on the machine.

In a more elaborated variant (appear 16C) it second sleeve 101 is placed inside sleeve 91 with a going back to its base by an universal arm 104 allowing control in all the directions of the cyclic, it is then the slope of the handle 102 with regard to sleeve 101 that ensures, by the action of a cable put in its center, the movement of the cross 103, and ensures the pinching of rings because of the relative wind at the same moment.

The interest of this variant lies in the fact that the pilot uses only a pedal and a hand, this free movement allows him to ensure the missions that must allow the use of the machine in complete safety more easily without having to resort to a passenger.

More exactly in this operation and more safety for the postage of variations as a cause interference of pitch due to the possible beating of wing in held tolerances on connection by rods 52A/52B can be usefully replaced by a connection by cable with fixation of the ends of the girdles of cable, on the one hand on the crown and on the other hand on the muff by means of a dismissal of muff of wing with regards to the foot of wing for more precision in the control (not presented here).

More precisely in another setting up between the wing feet and the muffs of wing foot, an engine of position allows the cyclic regulation of the angle of wings, this engine is controlled by an electronics, itself controlled by a signal whose function is the mathematically show of ring in space in the various speeds of flight, this mathematical function has for entrance the synchronized marketing research of four cables 82 guiding general pitche, reeling and rolling and that of four cables 86 guiding the space of rings at the same time (lace), and by plucking (in a cyclical way for the compensation due to the relative wind).

The reach of the present invention does not limit itself to the details of the forms above considered as not restrictive examples but to a larger extent is of a wider scope, being possible for the man of art to modify it, considering the explanations above as a frame.

1. Aircraft with rotary wings here described is of said gyropter type containing a central cabin around which are mobile in rotation two synchronized opposite rotary coaxial rotors presenting each a crown (2, 3) and at least two wings, the cabin containing two structural rings (10, 11) connected among them by crossbars and serving of guides for rotors, some means being planned to modify the pitch of every wing,
characterized in that the means allowing to modify the pitch of wing are made of two oscillating rings (31, 32), every oscillating ring being associated to a crown (2, 3) in being concentric to the aforementioned crown, pulled in rotation by the crown, linked to the wings of the corresponding crown by means of movement transmission of rods or the cables adapted to modify the pitch of aforementioned wings,
in that every oscillating ring (31, 32) is linked to means of vertical transport and movement around a transversal axis allowing so to present a chosen distance facing the corresponding crown (2, 3) along a circumference, and
in that the gearing of crowns on the structural rings (10, 11) is done thanks to pebbles (30) of perpendicular axis containing a structural ring and the corresponding crown, pebbles and rings spread equally between the structural ring and the corresponding crown and to each wing one or two pebbles is corresponding.

2. Aircraft with rotary wings according to claim 1, characterized in that each crowns presents a tilted of training, the two tracks facing each other, the training of crowns is ensured by a unclogged conical tangential wheel.

3. Aircraft with rotary wings according to claim number 2, characterized in that a free wheel of brake is set at the opposite of the tangential wheel of training.

4. Aircraft according to the claims 1-3, characterized in what the oscillating rings are geared by the action on an arm of joint (57) slightly horizontal to which are connected two kneepads carrying each a ball and by their intermediary two slightly vertical stirrups (46, 47) carrying each a system of movement allowing the movement of the oscillating ring (31, 32) corresponding.

5. Aircraft according to claim 4, characterized in that each arm of joint (57) is geared from a mobile handlebars according to two axes and by a rudder containing two pedals, and in that the movement of the handlebars and the rudder is passed on to the oscillating rings thanks to rods that can use cable to allow their transverse angular position and their vertical position to vary with regard to crowns as well as their vertical spacing.

6. Aircraft according to claim 4 or 5, characterized in that the vertical means of transport (Z) of the oscillating rings (31, 32) include, on each side of the cabin (1), an arm of control (36) of the oscillating rings (31, 32) set according to a slightly longitudinal direction (X), linked to a vertical training means (centre Z) in the middle (49) set according to the transversal axis of the aircraft, each arm of control (36) carring in both sides a set (56) of control of pitch including a device (57, 46, 47) able to modify vertical spacing between two oscillating rings (31, 32) and allowing their free movement during their rotation, the means of transport around the transversal axis (Y) oscillating rings (31, 32) include means (51, 58, 50) of training in rotation of each arm of control (36) around a transversal axis (Y), that the means of training in rotation of every arm of control (36) includes a pedal united (51) of a rod (58) linked to arm of control (36), with handlebars (35) that can move according to two axes, whose handles are each connected to a bar (40) being able to be moved into simultaneous vertical movement (Z) (pushed of pulled handlebars) or opposed (handlebars turned on one side or the other onet), that each set (56) of control of pitch is made of slightly horizontal arm of joint (57) to which are connected two kneepads carrying each a ball and by their intermediary two slightly vertical stirrups (46, 47) carrying each a system of movement allowing the movement of an oscillating ring (31, 32), that a wheel (37) to every end of every arm of control (36), closely linked to articulated (57), and is made to turn by a cable (38, 39) therefore modifying so the center distance of two oscillating rings (31, 32).

7. Aircraft according to claim 4, characterized in that each articulated arm of joint (57) is controlled from a set of two sleeves and a rudder, in that the movement of sleeves and rudder is passed on to the oscillating rings of sliding cables in one girdle connected with the structure of the aircraft by means of a cross-like tool to allow to vary the transverse angular position of the oscillating rings and their vertical position to wary, with regards to crowns as well as their vertical spacing.

8. Aircraft according to claim 1-3, characterized in that the oscillating rings are controlled by cables which are in direct connection to remote control servomotors (drone or automatic piloting).

9. Aircraft according to claims 1-8, characterized in that it is also made of at least a circular ring for the guidance of whirlpools, being therefore a wind flow vibration absorbent, for safety landing for protection, whose diameter is more important than that of the wings (2A, 2B, 3A, 3B), and in that the circular ring of protection is a supple ribbon, linked to the ends of a couple of wings (3A, 3B), and moving at the same time with the wings.
